(19) United States
(12) Patent Application Publication
(10) Pub. No.: US 2023/0202157 A1
(43) Pub. Date: Jun. 29, 2023

(54) AN ASEPTIC LIQUID PACKAGING CONTAINER

(71) Applicant: UFLEX LIMITED, New Delhi (IN)

(72) Inventor: Ashok Chaturvedi, Sugarland, TX (US)

(21) Appl. No.: 18/000,740

(22) PCT Filed: Jun. 5, 2021
(86) PCT No.: PCT/IN2021/050550

§ 371 Date: Dec. 5, 2022

(30) Foreign Application Priority Data
Jun. 6, 2020 (IN) 202011023791

(51) Int. Cl. B32B 27/10; B65D 5/74; B65D 85/00; B65D 5/56; B65D 5/62; B32B 7/12; B32B 27/32; B32B 27/08; D21H 19/84; D21H 19/58; D21H 19/40; D21H 19/68; D21H 19/04; D21H 19/08; D21H 27/10

(52) U.S. Cl. CPC B32B 27/10; B32B 7/12; B32B 27/08; B32B 27/327; B65D 5/62; B65D 5/563; B65D 5/746; B65D 85/70; D21H 19/04; D21H 19/08; D21H 19/40; D21H 19/58; D21H 19/68; D21H 19/84; D21H 27/10; B32B 2255/10; B32B 2255/12; B32B 2255/26; B32B 2255/205; B32B 2307/75; B32B 2307/718; B32B 2307/7244; B32B 2439/62; B32B 2439/70

(57) ABSTRACT

An aseptic liquid packaging container (100) is disclosed. The liquid packaging container made from a cup stock paperboard and may be a laminate structure (200b) configured to form the container. It can be a plurality of layers configured to form the laminate structure (200b) wherein at least one layer of the plurality of layers is a cup stock paperboard layer (204b).

### FIELD OF THE DISCLOSURE

The present disclosure generally relates to a liquid packaging container and more particularly, to an aseptic Liquid Packaging Container made from a cup stock paperboard for packaging of liquid / fluids, oils etc.

### BACKGROUND OF THE DISCLOSURE

Aseptic liquid packaging containers for packaging, storage and transportation of liquid products are widely used in the packaging industry. Normally, such containers are made from laminates consisting of core layer of paper or paperboard (204a) to achieve shape and stability as shown in FIG. 2A. Both sides of the core layer of paper or paperboard are applied with liquid-resistant coatings / layers to effectively protect the core layer of liquid-absorbing fibers against penetration by moisture. These liquid-resistant layers normally consist of thermoplastic, preferably polyethylene, which also imparts superior thermo sealing properties to the packaging material. The coatings may be of suitable formulation imparting the barriers against moisture and gases, protecting core layers of paper or paper board.

Various types of containers of above described type for packaging have been disclosed in various prior arts. For example, US6048295 discloses a method of forming of packaging containers from paper core laminate. US7288302 discloses packaging laminate including core layer of paper or paperboard and container made from such laminate. Further, EP0461116A1 discloses a gable top brick pack for liquid packaging which are manufactured from foldable packaging substrate, such as laminates having paper or paperboard (204a) as a core layer.

These types of containers have been satisfactory for their intended purposes in many respects, but costly in manufacturing. The use of conventional paperboard known as Liquid Packaging Board (LPB) as core material to provide strength in the desired shape of the container, results in higher cost. LPB is manufactured by limited suppliers so the availability and stable pricing is a challenge. Therefore, it is desired to have an option which can significantly reduce cost of manufacturing of pack, ensuring easy availability and meeting all the technical and aesthetic requirements.

As mentioned above, in order to fulfill the needs, the present invention provides an aseptic Liquid Packaging Container, with strength and other features similar to the existing packs but having significantly low laminate cost having a different paper board material for core which is also available easily.

### OBJECT OF INVENTION

The object of present invention is to provide an aseptic Liquid Packaging Container made up of cup stock paperboard for packaging of liquid beverages, such as- juices, milk, oils and the like products.

An object of the present invention is to provide an aseptic Packaging Container made from a laminate having cup stock paperboard and other polymeric layers.

Another object of present invention is to provide a low cost aseptic liquid Packaging Container, which is easily available to preserve liquids inside for a standard shelf life.

Further object of the present disclosure is to provide brick pack, particularly adapted for aseptic packaging of liquid items such as, juices, milk, liquor, oil and the like, which is formed having optimum dimensions and location of a pour spout fitment thereon. The dimensions of the pour spout components are preferred with optimum performance. The container optionally carries a dispensing opening.

### SUMMARY OF THE DISCLOSURE

The present invention relates to an aseptic liquid packaging container for packing liquid. The container comprises a laminate structure made from a cup stock paperboard configured to form the wall, bottom surface and top surface of the container and a dispensing means. The liquid dispensing means is disposed on any of the surfaces or the wall of the container. The liquid dispensing means is selected from a spout or a cap or a straw hole or scissor cut. The shape of the container can be selected from a cuboid, cylindrical, prism, pyramid, conical or any three-dimensional shape for holding the content.

The laminate structure of cup stock paperboard comprises a first low density polyethylene (LDPE) layer, a layer of cup stock paperboard layer, a second LDPE layer, a barrier protection layer made up of aluminum foil or metalized aluminum, a third LDPE adhesive polymer layer as a binding layer, and a metallocene layer. The cup stock paperboard layer is coated with clay (CaCO₃) on one side or both the sides. The cup stock paperboard layer is in the range of 180 to 310 GSM. The cup stock paperboard layer has printing on the side that is covered by first low density polyethylene (LDPE) layer. The barrier protection layer is metal coating made up of aluminum foil or metalized aluminum or vacuum aluminum any other metal coating.

This together with the other aspects of the present disclosure, along with the various features of novelty that characterize the present disclosure, are pointed out with particularity in the description, along with the abovementioned summary, annexed hereto and form a part of the present disclosure. For a better understanding of the present disclosure, its operating advantages and the specified object attained by its uses, reference should be made to the accompanying drawings and descriptive matter in which there are illustrated exemplary embodiments of the present disclosure.

### BRIEF DESCRIPTION OF THE DRAWINGS

The advantages and features of the present disclosure shall be better understood with reference to the following detailed description taken in conjunction with the accompanying drawing, wherein like elements are identified with like symbols and in which:

FIG. 1 illustrates a perspective view of an aseptic liquid packaging container, in accordance with an exemplary embodiment of the present disclosure; and

FIGS. 2A & 2B, illustrate cross section views of a typical laminate for making the aseptic liquid packaging container of FIG. 1, in accordance with an exemplary embodiment of the prior art and present disclosure respectively.

Like reference numerals refer to like parts throughout the description of several views of the drawings.

### DETAILED DESCRIPTION OF THE DISCLOSURE

For a thorough understanding of the present disclosure, reference is to be made to the following detailed description in connection with the above-mentioned drawings. Although the present disclosure is described in connection with exemplary embodiments, the present disclosure is not intended to be limited to the specific forms set forth herein. It is understood that various omissions and substitutions of equivalents are contemplated as circumstances may suggest or render expedient, but these are intended to cover the application or implementation without departing from the spirit or scope of the present disclosure. Further, it will nevertheless be understood that no limitation in the scope of the disclosure is thereby intended, such alterations and further modifications in the figures and such further applications of the principles of the disclosure as illustrated therein being contemplated as would normally occur to one skilled in the art to which the disclosure relates. Also, it is to be understood that the phraseology and terminology used herein is for the purpose of description and should not be regarded as limiting. Further, reference herein to “one embodiment” or “an embodiment” means that a particular feature, characteristic, or function described in connection with the embodiment is included in at least one embodiment of the disclosure. Furthermore, the appearances of such phrase at various places herein are not necessarily all referring to the same embodiment. The terms “a” and “an” herein do not denote a limitation of quantity, but rather denote the presence of at least one of the referenced item.

In view of the foregoing shortcomings inherent in the prior-art, the general purpose of the present disclosure is to provide an aseptic liquid packaging container made from cup stock paperboard as core layer instead of expensive Liquid Packaging Board, that is configured to include all advantages of the prior art and to overcome the drawbacks inherent in the prior art offering some added advantages.

The cup stock paperboard is easily available in the market at much lower price than Liquid Packaging Board resulting in economical package without compromising on quality.

To achieve the above objectives, in an aspect of the present disclosure, an aseptic Liquid Packaging Container is provided for packing liquid. The packaging container is formed by multilayer laminate, which includes at least one cup stock paperboard layer which on both sides thereof configures with at least one polymeric layer.

In an aspect, the present invention provides an aseptic liquid packaging container (100) for packing liquid. The container (100) comprises a laminate structure (200b) cup stock paperboard configured to form the wall (102, 102b, 104a, 104b), bottom surface (106), surface (108) of the container (100) and a dispensing means (110).

The laminate structure (200b) of cup stock paperboard comprises a first low density polyethylene (LDPE) layer (206b), a layer of cup stock paperboard layer (204b), a second LDPE layer (210b), a barrier protection layer (202b) made up of aluminum foil or metalized aluminum, a third LDPE adhesive polymer layer (208b) as a binding layer, and a metallocene layer (212b).

An exemplary embodiment of the present invention uses a multilayer laminate structure of packaging substrate essentially comprising the cup stock paperboard coated with Clay (CaCO₃) on the outer side or both the sides which gives good printing effect in comparison to uncoated cup stock paperboard. Further, such laminates typically have printing on one side of the cup stock paperboard and a layer of LDPE (Low density polyethylene) over the printing. On the other side of the paperboard another layer of LDPE is applied which is laminated with a barrier protection layer of Aluminum foil or vacuum metalized Aluminum or any other metal film or coating, using a binding layer. The other surface of the Aluminum is further laminated with a layer of LDPE Adhesive Polymer and a Metallocene Layer, making it six-layer structure. The GSM of Cup Stock Paperboard ranges from 180 to 310 depending upon the size and strength requirements of the container. The aseptic Liquid Packaging Container formed by such laminates includes, two pairs of opposite side walls, a bottom surface and a top surface; and optionally include a liquid dispensing means such as spout, cap, and straw hole disposed on the top surface.

In an exemplary embodiment, the present invention provides a multilayer laminate structure of packaging substrate essentially comprising six layers’ laminate structure having the cup stock paperboard coated with Clay (CaCO₃) The aseptic liquid Packaging Container formed by such laminate includes, two pairs of opposite side walls, a bottom surface and a top surface and optionally include a liquid dispensing means such as spout, cap, straw hole or scissor cut, disposed on any of the surfaces or walls.

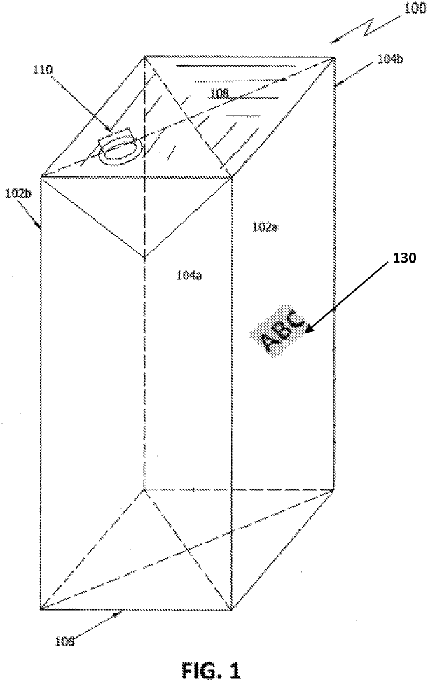

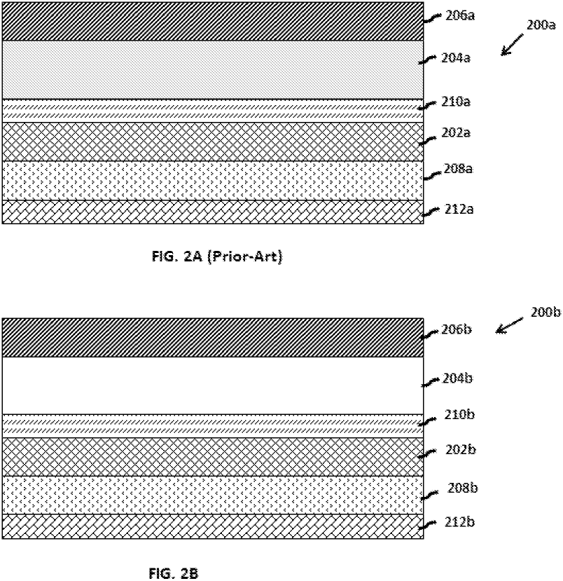

Referring now to FIG. 1 an aseptic liquid packaging container (100) (hereinafter referred to as “container (100)”) and FIG. 2B showing a laminate structure (200b) for making such container (100) made from a cup stock paperboard is illustrated in accordance with an exemplary embodiment of the present disclosure. As shown in FIG. 1, the container (100) is made from the cup stock paperboard layer and may be formed by the laminate structure having a plurality of layers as required by the producer, which includes at least one cup stock paperboard layer which on both sides thereof configures at least one polymeric layer. The laminate structure consists of the plurality of layers, which includes first Low Density Polyethylene (LDPE) layer (206b) used as waterproof and makes the contents antibacterial, a cup stock paperboard layer (204b) to increase durability, a LDPE Laminate (210b), a barrier protection layer (202b) i.e. Aluminum foil or metalized Aluminum, to create resistance against oxygen permeation, an LDPE Adhesive Polymer layer (208b) as a binding layer, and another PE layer i.e. Metallocene layer (212b) to seal off the liquid contents as shown in FIG. 2B.

In accordance with an embodiment of the present invention, the barrier protection layer (202b) may also include coatings or barrier protection layer of Aluminum foil or metalized Aluminum or any other metal coating (not shown). Suitable binding layers may be used to configure laminate structure (200b), wherever required.

In accordance with an embodiment of the present invention, the aseptic liquid Packaging Container (100) formed by such cup stock paper includes, two pairs of opposite side walls (102a), (102b) and (104a), (104b), a bottom surface (106) and a top surface (108); and optionally a dispensing means (110) disposed on a top surface (108) from which the contents of container (100) can be poured when opened. In some of the embodiments the dispensing means (110) can be located anywhere on the container (100) depending upon the requirement or design. It should also be appreciated that the dispensing means (110) can be a spout or a cap or a straw hole or any other dispensing means. In case of without caps & closer, the dispensing means (110) are generally scissor cut. The container (100) on it’s at least one of the side walls (102a), (102b) and (104a), (104b), the bottom surface (106) and the top surface (108). The shape of the pack is not limited to a cuboid, cylindrical, prism, pyramid, conical and it could be any three-dimensional shape holding the content.

The cup stock paperboard used in the laminate structure is easily available in the market at economical prices and has recycling characteristics which reduces the overall cost of the manufacturing of the pack. It is easy to print on the cup stock paperboard layer coated with Clay (CaCO₃). Further, the container (100) of the present disclosure is functionally and aesthetically similar to the packs in the market. Further, the container (100) is capable of packaging, storing, handling and carrying of all kind of liquid such as juices, milk, alcoholic drinks, water, oils, creams etc. in a convenient manner.

The foregoing descriptions of specific embodiments of the present disclosure have been presented for purposes of illustration and description. They are not intended to be exhaustive or to limit the present disclosure to the precise forms disclosed and obviously many modifications and variations are possible in light of the above teaching. The embodiments were chosen and described in order to best explain the principles of the present disclosure and its practical application, to thereby enable others skilled in the art to best utilize the present disclosure and various embodiments with various modifications as are suited to the particular use contemplated. It is understood that various omission and substitutions of equivalents are contemplated as circumstance may suggest or render expedient, but such are intended to cover the application or implementation without departing from the spirit or scope of the present disclosure.

### TECHNICAL ADVANCEMENTS

The present disclosure described hereinabove has several technical advantages including, but not limited to an aseptic liquid container for packing liquid. The technical advancement of the present invention is that the aseptic liquid packaging container formed is economical as cup stock paper is cheaper in price than Liquid Packaging Board (LPB) and is easily available in the market. The cup stock paperboard layer coated with Clay (CaCO₃) gives good printing effect in comparison to uncoated cup stock paperboard.

While considerable emphasis has been placed herein on the specific features of the preferred embodiment, it will be appreciated that many additional features can be added and that many changes can be made in the preferred embodiment without departing from the principles of the disclosure. These and other changes in the preferred embodiment of the disclosure will be apparent to those skilled in the art from the disclosure herein, whereby it is to be distinctly understood that the foregoing descriptive matter is to be interpreted merely as illustrative of the disclosure and not as a limitation.

1. An aseptic liquid packaging container for packing liquid comprising:
a laminate structure having a cup stock paperboard configured to form walls, a bottom surface and a top surface of the container
wherein the cup stock paperboard is coated with clay on one side or both the sides.

2. The aseptic liquid packaging container according to claim 1, wherein the laminate structure comprises:
i. a first low density polyethylene (LDPE) layer;
ii. a layer of cup stock paperboard layer;
iii. a second LDPE layer;
iv. a barrier protection layer;
v. a third LDPE adhesive polymer layer as a binding layer; and
vi. a metallocene layer.

3. The aseptic liquid packaging container according to claim 2, wherein grams per square meter (GSM) of the cup stock paperboard layer is in the range of 180 to 310 GSM.

4. The aseptic liquid packaging container according to claim 2, wherein the cup stock paperboard layer comprises printing on the side covered by the first low density polyethylene (LDPE) layer.

5. The aseptic liquid packaging container according to claim 2, wherein the barrier protection layer comprises a metal coating comprising aluminum foil or vacuum metalized aluminum or any other metal film or metal coating.

6. The aseptic liquid packaging container according to claim 1, wherein the container comprises a dispensing means.

7. The aseptic liquid packaging container according to claim 7, wherein the liquid dispensing means is disposed on any one of the top surface (108) or bottom surface or the wall of the container.

8. The aseptic liquid packaging container according to claim 7, wherein the liquid dispensing means is selected from a spout or a cap or a straw hole or scissor cut.

9. The aseptic liquid packaging container according to claim 1, wherein the shape of the container is selected from a cuboid, cylindrical, prism, pyramid, conical or any three-dimensional shape for holding the content.
